(19) United States
(12) Patent Application Publication
(10) Pub. No.: US 2026/0044874 A1
(43) Pub. Date: Feb. 12, 2026

(54) METHOD AND SYSTEM FOR FACILITATING UTILIZATION OF REWARD POINTS

(71) Applicant: MASTERCARD INTERNATIONAL INCORPORATED, PURCHASE, NY (US)

(72) Inventors: Nitin GARG, Vadodara (IN); Anurag NIGAM, Vadodara (IN); Asif KADIWALA, Vadodara (IN); Divya Mahendrabhai YADAV, Hansot (IN); Manorama MARU, Vadodara (IN); Raj JADHAV, Vadodara (IN)

(21) Appl. No.: 18/801,570

(22) Filed: Aug. 12, 2024

(51) Int. Cl. G06Q 30/0226

(52) U.S. Cl. CPC G06Q 30/0233

(57) ABSTRACT

A method and system for facilitating utilization of reward points is provided. A set of users is identified from multiple users such that the reward points associated with payment modes of the set of users are set to expire after a first time period. Further, a transaction history of the set of users is analyzed to detect at least one transaction that is associated with a sustainable initiative for each of the set of users. Based on the analysis, users are selected from the set of users such that the transaction history of each of the selected users is associated with at least one of the sustainable initiatives. Further, the selected users are notified to donate the reward points that are set to expire to sustainable activities.

### FIELD

Various embodiments of the present disclosure relate generally to payment transaction systems. More particularly, various embodiments of the present disclosure relate to a method and system to facilitate utilization of reward points.

### BACKGROUND

In recent decades, the introduction of loyalty programs have significantly transformed consumer engagement in various industries. The loyalty programs offer users the opportunity to earn reward points through interactions, purchases, or other engagements with issuing entities (e.g., financial institutions, travel companies, retailers, or the like). The reward points serve as a form of virtual currency, often redeemable for discounts, goods, or services to incentivize users. Generally, the reward point may have limited validity and need to be redeemed within the validity period. Post the validity period, the reward points may expire, thereby providing limited utility to consumers. Consequently, a substantial percentage of the reward points expire every year unused, resulting in reduced overall effectiveness of the loyalty program.

In light of the foregoing, there is a need for a technical solution that solves the abovementioned problems and facilitates timely utilization of the reward points that are set to expire.

### SUMMARY

Method and system for facilitating utilization of reward points is provided substantially as shown in and described in connection with, at least one of the figures, as set forth more completely in the claims.

In an embodiment of the present disclosure, a method is provided. The method comprises, identifying, by a rewards server, a first set of users from a plurality of users based on reward points associated with a first set of payment modes, wherein the first set of payment modes is associated with the plurality of users, and wherein the reward points associated with each of the first set of users are set to expire after a first time period. The method further comprises initiating, by the rewards server, an analysis of a transaction history of at least one of the first set of users to detect that at least one transaction of the transaction history of the at least one of the first set of users is associated with a set of sustainable initiatives. Further, the method comprises selecting, by the rewards server, a second set of users from the first set of users, wherein the at least one transaction of the transaction history of each of the second set of users is detected to be associated with the set of sustainable initiatives. Additionally, the method comprises communicating, by the rewards server, a dataset of the second set of users to a first issuer server such that each of the second set of users is notified on a corresponding user device by the first issuer server to donate the reward points that are set to expire to a set of sustainable activities.

In some embodiments, the method further comprises receiving, by the rewards server, a first configuration value of the first time period and a second configuration value of a second time period from the first issuer server, wherein the second configuration value indicates a time interval to periodically initiate the identification of the first set of users based on the first time period. Additionally, the method comprises configuring, by the rewards server, the first time period and the second time period based on the first configuration value and the second configuration value, respectively, wherein the first time period is configured with the first configuration value to identify the first set of users.

In some embodiments, the method further comprises retrieving upon identifying the first set of users, by the rewards server, the transaction history associated with each of the first set of users from a database associated with the rewards server based on a first set of identifiers associated with the first set of payment modes associated with each of the first set of users to initiate the analysis of the transaction history.

In some embodiments, the method further comprises determining upon identifying the first set of users, by the rewards server, whether a second set of payment modes is issued to the first set of users, wherein the second set of payment modes is associated with a plurality of issuers that are different from a first issuer associated with the first issuer server. Further, the method comprises generating, by the rewards server, a first request that comprises a second set of identifiers associated with the second set of payment modes that is determined to be issued to the first set of users. Additionally, the method comprises, retrieving, by the rewards server, based on the first request, the transaction history associated with the first set of users from an open banking server to initiate the analysis of the transaction history.

In some embodiments, the method further comprises determining to analyze the transaction history of each of the first set of users, by the rewards server, whether the at least one transaction of the transaction history of the at least one of the first set of users is linked with a transaction category code of a plurality of transaction category codes, wherein the plurality of transaction category codes are mapped with the set of sustainable initiatives, and wherein when the at least one transaction of the transaction history corresponds to the transaction category code, the at least one transaction is detected to be associated with the set of sustainable initiatives.

In some embodiments, the method further comprises extracting based on the selection of the second set of users, by the rewards server, details of the reward points associated with at least one of the second set of users from a database associated with the rewards server, wherein the details include a balance and the first time period associated with the reward points, and wherein the dataset of the second set of users includes the details of the reward points that are set to expire for each of the second set of users and an identifier of each of the second set of users.

In some embodiments, the method further comprises receiving upon notifying to donate the reward points, by the rewards server, a first selection to donate the reward points to the set of sustainable activities from the first issuer server, wherein the first selection is associated with at least one of the second set of users. Further, the method comprises associating upon receiving the first selection, by the rewards server, the set of sustainable activities to the reward points that are set to expire for the at least one of the second set of users. Additionally, the method further comprises providing, by the rewards server, at least one of the set of sustainable activities to the first issuer server to receive a confirmation of donation of the reward points to the set of sustainable activities.

In some embodiments, the method further comprises generating, by the rewards server, a redemption request for an acquirer server, to redeem the reward points to be donated based on a confirmation to donate the reward points by at least one of the second set of users to the set of sustainable activities. Further, the method comprises determining, by the rewards server, that the reward points have been successfully redeemed based on a redemption response from the acquirer server. Additionally, the method further comprises authorizing, by the rewards server, donation of the reward points that are successfully redeemed to the set of sustainable activities based on the determination of successful redemption.

In some embodiments, the reward points correspond to one of cashback points, loyalty points, gift coupons, and bonuses.

In some embodiments, the set of sustainable activities corresponds to at least one of environmental conservation, animal welfare, sustainable development, or community development.

In some embodiments, the set of sustainable initiatives corresponds to at least one of farming and agriculture, gardening and landscaping services, environmental services, renewable energy products and services, environmental and ecological organizations, recycling centers, green products and services, and biofuels.

In another embodiment of the present disclosure, a system comprising a rewards server is provided. The rewards server is configured to identify a first set of users from a plurality of users based on reward points associated with a first set of payment modes, wherein the first set of payment modes is associated with the plurality of users, and wherein the reward points associated with each of the first set of users are set to expire after a first time period. The rewards server is further configured to initiate an analysis of a transaction history of at least one of the first set of users to detect that at least one transaction of the transaction history of the at least one of the first set of users is associated with a set of sustainable initiatives. The rewards server is further configured to select a second set of users from the first set of users, wherein the at least one transaction of the transaction history of each of the second set of users is detected to be associated with the set of sustainable initiatives. Further, the rewards server is configured to communicate a dataset of the second set of users to a first issuer server such that each of the second set of users is notified on a corresponding user device by the first issuer server to donate the reward points that are set to expire to a set of sustainable activities.

In some embodiments, the rewards server is further configured to receive a first configuration value of the first time period and a second configuration value of a second time period from the first issuer server, wherein the second configuration value indicates a time interval to periodically initiate the identification of the first set of users based on the first time period. Additionally, the rewards server is further configured to configure the first time period and the second time period based on the first configuration value and the second configuration value, respectively, wherein the first time period is configured with the first configuration value to identify the first set of users.

In some embodiments, the rewards server comprises a memory, wherein the memory is configured to store the transaction history associated with the first set of payment modes, and wherein the transaction history is stored for each of the first set of users.

In some embodiments, the rewards server is further configured to determine upon identifying the first set of users, whether a second set of payment modes is issued to the first set of users, wherein the second set of payment modes is associated with a plurality of issuers that are different from a first issuer associated with the first issuer server, and wherein the first set of payment modes is associated with the first issuer. Further, the rewards server is configured to generate, a first request that comprises a second set of identifiers associated with the second set of payment modes that is determined to be issued to the first set of users. Additionally, the rewards server is further configured to retrieve the transaction history associated with each of the first set of users from an open banking server based on the first request, wherein the transaction history is retrieved to initiate the analysis of the transaction history.

In some embodiments, to analyze the transaction history of each of the first set of users, the rewards server is further configured to determine whether the at least one transaction of the transaction history of the at least one of the first set of users is linked with a transaction category code of a plurality of transaction category codes, wherein the plurality of transaction category codes are mapped with the set of sustainable initiatives, and wherein when the at least one transaction of the transaction history is determined to be linked with the transaction category code, the at least one transaction of the transaction history is detected to be associated with the set of sustainable initiatives.

In some embodiments, the dataset of the second set of users includes details of the reward points that are set to expire for each of the second set of users, and an identifier of each of the second set of users, wherein the details of the reward points include a balance and the first time period of the reward points.

In some embodiments, the rewards server is further configured to receive upon notifying to donate the reward points, a first selection to donate the reward points to the set of sustainable activities from the first issuer server, wherein the first selection is associated with at least one of the second set of users. Further, the rewards server is configured to associate upon receiving the first selection, the set of sustainable activities to the reward points that are set to expire for the at least one of the second set of users. Additionally, the rewards server is further configured to provide at least one of the set of sustainable activities to the first issuer server to receive a confirmation of donation of the reward points to the set of sustainable activities.

In some embodiments, the rewards server is further configured to generate a redemption request for an acquirer server, to redeem the reward points to be donated based on a confirmation to donate the reward points by at least one of the second set of users to the set of sustainable activities. The rewards server is further configured to determine that the reward points have been successfully redeemed based on a redemption response from the acquirer server. Additionally, the rewards server is configured to authorize donation of the reward points that are successfully redeemed to the set of sustainable activities based on the determination of successful redemption.

In some embodiments, the reward points correspond to one of cashback points, loyalty points, gift coupons, and bonuses. Further, the set of sustainable activities corresponds to at least one of environmental conservation, animal welfare, sustainable development, or community development. Additionally, the set of sustainable initiatives corresponds to at least one of farming and agriculture, gardening and landscaping services, environmental services, renewable energy products and services, environmental and ecological organizations, recycling centers, green products and services, and biofuels.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates a system for facilitating utilization of reward points, in accordance with an exemplary embodiment of the present disclosure;

FIGS. 2A-2D are schematic diagrams that illustrates UI screens, that are rendered on a user device of the system of FIG. 1, in accordance with an exemplary embodiment of the present disclosure;

FIGS. 3A-3D collectively represent a process flow diagram that illustrates an exemplary method of facilitating utilization of the reward points by the system of FIG. 1, in accordance with an exemplary embodiment of the present disclosure;

FIGS. 4A-4C, collectively, represent a flow chart that illustrates the method for facilitating utilization of the reward points by a rewards server of the system of FIG. 1, in accordance with an exemplary embodiment of the present disclosure;

FIG. 5 represents a high-level flow chart that illustrates a method (or process) for facilitating utilization of the reward points by the rewards server, in accordance with an exemplary embodiment of the present disclosure; and

FIG. 6 is a block diagram that illustrates a system architecture of a computer system, in accordance with an embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### OVERVIEW

Generally, when a user engages in a transaction, reward points are credited to an account associated with the user. The reward points have limited validity, and may only be redeemed within the limited validity against various benefits, such as discounts, goods, or services. Each year a considerable portion of reward points go unused and expire automatically, representing a loss of potential value for the user. Additionally, following the redemption of points for rewards, any remaining residual points often fall below the threshold required for further redemptions and consequently expire without utility. Service providers may provide the user with options to donate the unused reward points to charities. However, the absence of categorization and personalization of donation opportunities may result in a low inclination of the user to contribute the unused reward points to random charities. Consequently, the user may feel disconnected from charitable causes and uncertain about the impact of donations, further diminishing the inclination to contribute the unused reward points to the charities.

Various embodiments of the present disclosure provide a method and a system that solve the abovementioned problems by facilitating utilization of reward points for sustainable activities. The method includes identifying a first set of users from a plurality of users based on reward points associated with a first set of payment modes of each of the plurality of users. The first set of payment modes is associated with a first issuer. The reward points associated with at least one of the first set of payment modes of each of the first set of users are set to expire after a first time period. Further, an analysis of a transaction history of at least one of the first set of users is initiated based on the identification of the first set of users. The analysis may be initiated to detect at least one transaction of the transaction history that is associated with at least one of a set of sustainable initiatives. Additionally, a second set of users is selected from the first set of users upon detection of the at least one transaction of the transaction history of each of the second set of users to be associated with the set of sustainable initiatives (e.g., farming and agriculture, gardening and landscaping services, environmental services, renewable energy products and services, or the like). Further, a dataset of the second set of users is communicated to a first issuer server associated with the first issuer. Based on the dataset of the second set of users, the first issuer server notifies each of the second set of users on a corresponding user device to donate the reward points that are set to expire to at least one of a set of sustainable activities (e.g., environmental conservation, animal welfare, sustainable development, community development, or the like).

Thus, the present disclosure presents a solution to the persistent issue of unused and expiring reward points by leveraging transaction history to identify users that are interested in donating towards sustainable initiatives. Based on the identification of the users, targeted notifications can be delivered on corresponding user devices to donate the expiring reward points. Further, based on an assessment of the transaction history, the users are associated with relevant charitable organizations that aligns with preferences of the users, thereby increasing chances of donating towards the sustainable initiatives. Hence, the present disclosure provides a convenient and seamless solution to facilitate utilization of reward points.

### Terms Description (in Addition to Plain and Dictionary Meaning)

Payment mode is a medium that facilitates access to a financial account maintained at a financial institution utilized to make financial transaction such as payments from the financial account. Examples of the payment mode may include but are not limited to, a payment card, a digital wallet, a unified payment interface (UPI), or the like.

Reward points are incentives granted to users of various payment modes. The reward points accumulate based on transactions performed through the payment modes. Examples of reward points may include cashback points, loyalty points, gift coupons, bonuses, or the like.

Sustainable initiatives refer to any project, service, organization, or product that supports environmental preservation and sustainability. Examples of the sustainable initiatives may include farming and agriculture, gardening and landscaping services, environmental services, renewable energy products and services, environmental and ecological organizations, recycling centers, green products and services, biofuels, or the like.

Sustainable activities refer to charitable initiatives that aligns with environmental, social, and governance (ESG) objectives. Examples of the sustainable activities may include environmental conservation, animal welfare, sustainable development, community development, or the like. These Sustainable activities may complement the sustainable initiatives by addressing broader social and environmental goals.

Server is a physical or cloud data processing system on which a server program runs. A server may be implemented in hardware or software, or a combination thereof. In one embodiment, the server is implemented as a computer program that is executed on programmable computers, such as personal computers, laptops, or a network of computer systems. The server may correspond to a secure server, an acquirer server, a payment network server, or a first issuer server.

First issuer server ensures payment for approved transactions in accordance with various payment network regulations and local legislation. In addition, the first issuer server facilitates utilization of the reward points to the users.

First issuer is associated with a financial institution, such as a bank, where accounts of a plurality of users are established and maintained. The first issuer maintains the first issuer server. In one embodiment, the first issuer issues the payment mode to the users

Payment transaction is an exchange of funds between two or more parties. For example, the payment transaction may include transferring a transaction amount from a user account to a merchant account, when a user makes a purchase from a merchant. In another example, the payment transaction may include dispensing cash, by an ATM, equivalent to a transaction amount debited from the user account based on a request from the user. The payment transaction is performed at one of a payment terminal device or a user device. Furthermore, the payment transaction also includes an inquiry, or any other operation that is performed by using a transaction card at any one of the payment terminal device or the user device.

User device is an electronic communication device that receives various notifications related to the reward points (e.g., redemption of the reward points) from first issuer server. The user device further enables the first user to view and donate reward points to one of a set of sustainable activities. Examples of the user device include a mobile phone, a computer, a laptop, a smartphone, a tablet, a phablet, and/or the like.

A reward server is operated by a payment network. The payment network server settles transactions between various acquirer banks and issuer banks.

First time period corresponds to a time interval related to the expiration of the reward points.

Second time period corresponds to a time interval related to a frequency of a batch process to identify a first set of users with reward points that are set to expire after the first time period.

First set of payment modes may be associated with financial accounts of each of the plurality of users with the first issuer.

Second set of payment modes may be associated with financial accounts of each of the first set of users with a plurality of issuers that are different from the first issuer.

First set of identifiers may be associated uniquely with the first set of payment modes such that each identifier of the first set of identifiers may serve as an identification of one of the first set of payment modes. The first set of identifiers may comprise numeric values, alphanumeric values, or alphabetic values.

Open banking server is operated by various issuers (e.g., the plurality of issuers) that facilitates secure communication with third-party service providers (e.g., the payment network that operates the rewards server) through the APIs.

Plurality of transaction category codes may correspond to numeric identifiers to classify and categorize different types of transactions The plurality of transaction category codes may be uniquely mapped with the set of sustainable initiatives

Second set of identifiers may be associated uniquely with the second set of payment modes such that each identifier of the second set of identifiers may serve as an identification of one of the second set of payment modes. The second set of identifiers may comprise numeric values, alphanumeric values, or alphabetic values.

First selection is indicative of donating the reward points to the set of sustainable activities thereby confirming an interest from the second set of users to donate to the set of sustainable activities.

Redemption request corresponds to a message sent to the acquirer server 116 to redeem the reward points to be donated.

Redemption response correspond to a message sent to the processor 110 indicating an outcome of the redemption of the reward points. The redemption response may be indicative of success or failure of the redemption of the reward points.

Transaction history may correspond to previous transactions that relates to at least one of the first set of payment modes and the second set of payment modes that are associated with the first set of users.

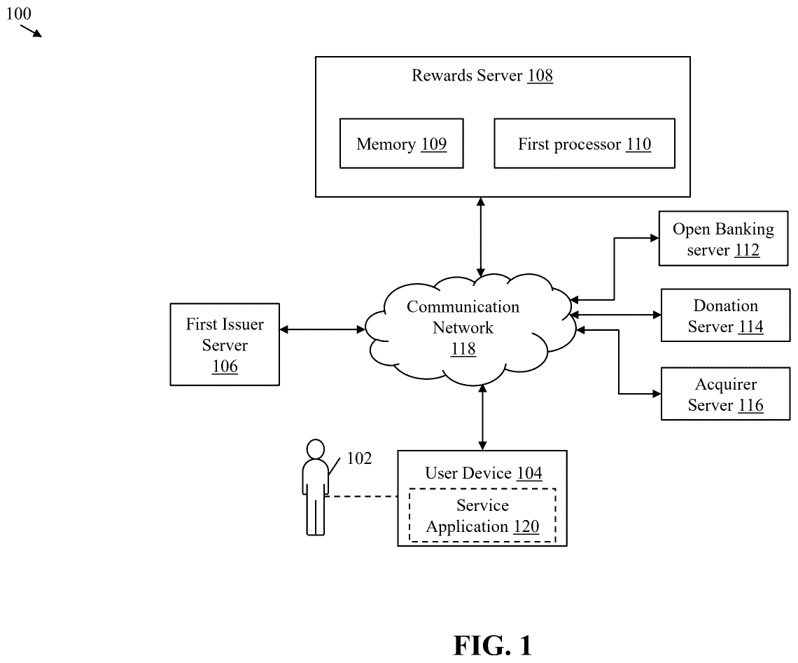

FIG. 1 is a block diagram that illustrates a system 100 for facilitating utilization of reward points, in accordance with an embodiment of the present disclosure. The system 100 includes a first user 102, a user device 104, a first issuer server 106, a rewards server 108, an open banking server 112, a donation server 114, and an acquirer server 116. The user device 104, the first issuer server 106, the rewards server 108, the open banking server 112, the donation server 114, and the acquirer server 116 may communicate with each other by way of a communication network 118 or through separate communication networks established therebetween.

The first user 102 is an account holder of at least one financial account. Examples of the financial account may include a savings account, a checking account, a debit account, a credit account, a digital wallet account, or the like. The financial account may be associated with a payment mode that facilitates the first user 102 to access the financial account. In one embodiment, the financial account is maintained by a financial institution, such as a bank (i.e., an issuer of the financial account; hereinafter, referred to as a “first issuer”). Thus, the first issuer is a financial institution that manages one or more financial accounts of a plurality of users such as the first user 102.

The first issuer may issue a first set of payment modes to each of the plurality of users that includes the first user 102. Thus, the first set of payment modes is associated with the first issuer. The first set of payment modes may include suitable logic, circuitry, interfaces, and/or code, executable by the circuitry to facilitate payments for availing services such as purchase of a product, transferring funds, and the like. The first set of payment modes may be associated with financial accounts of each of the plurality of users. In one embodiment, the first set of payment modes is a medium that facilitates each of the plurality of users (such as the first user 102) to access corresponding financial accounts (such as a first account of the first user 102) maintained at the first issuer. Further, the first set of payment modes may be associated uniquely with a first set of identifiers such that each identifier may serve as an identification of a corresponding payment mode. Each identifier may include numeric values, alphanumeric values, or alphabetic values. A payment mode may correspond to payment cards or e-wallets. Further, the payment cards may be either physical payment cards, virtual payment cards, or a combination thereof. Examples of the payment cards may include a credit card, a debit card, a prepaid card, a gift card, a rewards card, a loyalty points card, a frequent flyer miles card, or the like.

When the first user 102 engages in a payment transaction, the first issuer may credit reward points to the first account corresponding to the first user 102. The reward points may serve as a form of virtual currency, often redeemable for discounts, goods, or services. Examples of the reward points may include cashback points, loyalty points, gift coupons, bonuses, or the like. The credited reward points may have a set validity (e.g., few days or months) that is determined by the first issuer. Hence, the credited reward points may be redeemed within the limited validity.

The user device 104 may refer to a computing device of the first user 102. The first user 102 may own the user device 104. Examples of the user device 104 may include a mobile phone, a laptop, a smartphone, a tablet, a computer, a phablet, a wearable device such as a smart watch, or the like. The user device 104 may include suitable logic, circuitry, interfaces, and/or code to enable the first user 102 to perform various operations such as establishing communication with various devices by way of audio/video calls, sending/receiving short message services (SMSs), instant messages (IMs), and voice-over-internet protocol (VoIP) messages, performing payments, or the like. The user device 104 may be configured to receive, from the first issuer server 106, various notifications related to the reward points (e.g., redemption of the reward points). Further, the first user 102 may use the user device 104 to respond to the notifications.

The user device 104 may be further configured to execute or run a service application 120. The service application 120 may be hosted by the first issuer server 106. The first user 102 may log in to the service application 120 by entering a username and a password that is authenticated by the first issuer server 106. Upon authentication, access to the service application 120 is granted to the first user 102.

The service application 120 may facilitate various operations associated with the financial account and the payment mode of the first user 102. In an embodiment, the service application 120 may enable the first user 102 to view an account balance of the financial account of the first user 102. Further, the service application 120 presents the information related to the reward points. The information may pertain to a balance of the reward points, a first time period associated with the reward points, past purchases associated with reward points, or the like. In one embodiment, the reward points may be set to expire after the first time period. Thus, the first time period may correspond to a time interval related to the expiration of the reward points (e.g., the time interval beyond which the reward points expire). In an example, the service application 120 notifies the first user 102 on May 14, 2024 on the user device 104 that 200 reward points (e.g., the balance of the reward points) may expire on May 21, 2024.

The first issuer server 106 is a server arrangement that includes suitable logic, circuitry, interface, and/or code, executable by the circuitry, for processing various payment transactions. The first issuer server 106 is configured to receive various transaction requests for processing payment transactions. A received transaction request may include details of a corresponding payment transaction such as a transaction amount, a timestamp of the payment transaction, payment mode details of a payment mode used for initiating the payment transaction, or the like. The first issuer server 106 processes each payment transaction by approving or declining, based on the details of the payment transaction. The first issuer server 106 further credits, debits, or modifies one or more financial accounts of the plurality of users such as the first user 102 based on the processing of the payment transactions. Methods of processing the payment transactions via the first issuer server 106 will be apparent to persons having skill in the art and may include processing a payment transaction via the traditional four-party system or three-party system. The first issuer server 106 is operated by the first issuer. The first issuer server 106 is further configured to verify the plurality of users (e.g., the first user 102) during a login to service applications (such as the service application 120) based on stored authentication information (such as comparing received username and password with stored username and password).

The first issuer server 106 is provided with the options to configure the first time period and the second time period. The first issuer server 106 may select a first configuration value of the first time period. The first configuration value may be indicative of a time interval to identify the first set of users from the plurality of users such that the reward points associated with at least one of the first set of payment modes of each of the first set of users are set to expire after the first time period. Further, the first issuer server 106 selects a second configuration value of the second time period. In an embodiment, the second time period may correspond to a time interval related to a frequency of a batch process to identify the first set of users from the plurality of users. The second configuration value may be indicative of a time interval to periodically initiate identification of the first set of users based on the first time period. In other words, the second configuration value may be used to configure a frequency of identifying the first set of users from the plurality of users. For example, the first issuer server 106 may select the first configuration value as ten days and the second configuration value as twenty-four hours. Thus, the first set of users having the reward points expiring after ten days (e.g., the first time period) are identified from the plurality of users. Additionally, the identification is initiated every twenty-four hours (e.g., the second time period). In an embodiment, an issuer admin associated with the first issuer server 106 sets the first configuration value and the second configuration value of the first time period and the second time period, respectively. The working of the first issuer server 106 has further been explained in conjunction with the rewards server 108.

The communication network 118 is a medium through which content and messages are transmitted between the user device 104, the first issuer server 106, the rewards server 108, the open banking server 112, the donation server 114, and the acquirer server 116. Examples of the communication network 118 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system 100 may connect to the communication network 118 in accordance with various wired and wireless communication protocols, such as Transmission Control Protocol and Internet Protocol (TCP/IP), User Datagram Protocol (UDP), Long Term Evolution (LTE) communication protocols, or any combination thereof.

The rewards server 108 is a server arrangement that includes suitable logic, circuitry, interface, and/or code, executable by the circuitry, for managing reward point transactions. In one embodiment, the rewards server 108 may be operated by a payment network. Examples of various payment networks may include MasterCard®, American Express®, VISA®, Discover®, Diners Club®, or the like. In some embodiments, the rewards server 108 may correspond to digital payment platforms (e.g., PayPal®, Paytm®, Stripe®, or the like). In such an embodiment, the financial accounts of the plurality of users may be digital accounts maintained by the digital payment platforms and the first set of payment modes may correspond to e-wallets, virtual cards, unified payment interface (UPI), or the like. Further, the first set of identifiers associated with such first set of payment modes may include virtual user identifications (IDs), wallet IDs, virtual payment addresses, or the like. For the sake of simplicity of the ongoing description and without deviating from the scope of the disclosure, it is assumed that the rewards server 108 is a payment network server and the first issuer is the bank.

The rewards server 108 includes a first memory 109 and a processor 110. The first memory 109 includes suitable logic, circuitry, and/or interfaces to store various instructions or code which when executed by the processor 110 causes the processor 110 to categorize the plurality of users based on reward points that are set to expire thereby identifying the first set of users. The first memory 109 may include a database (e.g., a first tabular database or a first graphical database) that includes a relationship-mapping between the plurality of users and the first set of identifiers to store transaction history associated with the first set of payment modes corresponding to the plurality of users. In an example, the first user 102 may own a first debit card and a first credit card of the first set of payment modes. Thus, the first tabular database may include a mapping between a first identifier of the first debit card and a second identifier of the second credit card with the first user 102. Further, the transaction history executed by way of the first debit card and the first credit card is linked to the first user 102. The transaction history associated with the first set of payment modes may be alternatively referred to as “first historical data”. In an embodiment, the first memory 109 is further configured to store details of the reward points and an identifier of the first set of users in the database. The details of the reward points may include at least one of a balance and the first time period associated with the reward points. The identifier of each of the first set of users may correspond to a numeric or alphanumeric code that is uniquely associated with each of the first set of users. In an embodiment, the identifier may be linked with one of permanent account numbers, contact details, or the like for each of the first set of users.

Examples of the first memory 109 may include a random-access memory (RAM), a read-only memory (ROM), a removable storage drive, a hard disk drive (HDD), a flash memory, a solid-state memory, or the like. It will be apparent to a person skilled in the art that the scope of the disclosure is not limited to realizing the first memory 109 in the rewards server 108, as described herein. In another embodiment, the first memory 109 may be realized in form of a database server or a cloud storage working in conjunction with the rewards server 108, without departing from the scope of the disclosure.

The processor 110 includes suitable logic, circuitry, interfaces, and/or code, executed by the circuitry, for facilitating utilization of the reward points. Examples of the processor 110 may include, but are not limited to, an application-specific integrated circuit (ASIC) processor, a reduced instruction set computer (RISC) processor, a complex instruction set computer (CISC) processor, a field programmable gate array (FPGA), a central processing unit (CPU), or a microprocessor.

The processor 110 is configured to provide options to the first issuer server 106 to configure the first time period and a second time period. The processor 110 is further configured to receive the first configuration value of the first time period and the second configuration value of the second time period from the first issuer server 106. Further, the processor 110 may configure the first time period and the second time period with the first configuration value and the second configuration value, respectively.

The processor 110 is further configured to identify the first set of users based on the reward points associated with the first set of payment modes of each of the plurality of users that may expire after the first time period. In an example, the first set of users may include 10 users that have corresponding reward points that are set to expire after the first time period (e.g., 10 days). Further, the processor 110 may periodically initiate the identification of the first set of users based on the second time period (e.g., every 24 hours). In an example, the processor 110 may identify the first user 102 of the first set of users on May 15, 2024 such that the reward points of the first user 102 may expire on May 25, 2024 (e.g. after 10 days). Further, after 24 hours (e.g., on May 16, 2024), the processor 110 may identify a third user of the first set of users on May 16, 2024 such that the reward points of the third user may expire on May 26, 2024. The processor 110 is further configured to retrieve upon identifying the first set of users, transaction history associated with each of the first set of users from the first memory 109 based on the first set of identifiers of the first set of payment modes. Additionally, upon identifying the first set of users, the processor 110 is further configured to determine whether a second set of payment modes is issued to at least one of the first set of users.

The second set of payment modes may be associated with a plurality of issuers that are different from the first issuer. Thus, the second set of payment modes is associated with the plurality of issuers. In an embodiment, the processor 110 may communicate with credit bureaus to determine whether the second set of payment modes is issued to at least one of the first set of users. Examples of the credit bureaus may include Equifax®, Experian®, TransUnion®, or the like. The credit bureaus may share information pertaining to the second set of payment modes based on prior consent from each of the first set of users.

Although, it is mentioned that the processor 110 may communicate with credit bureaus, in numerous embodiments, the processor 110 may communicate with a plurality of payment networks, financial institutions, or the like to determine whether the second set of payment modes is issued to the first set of users.

The second set of payment modes may be associated uniquely with a second set of identifiers such that each of the second set of identifiers may serve as an identification of one of the second set of payment modes. The second set of identifiers may comprise numeric values, alphanumeric values, or alphabetic values. The second set of payment modes may be similar to the first set of payment modes. In an embodiment, the processor 110 determines that the second set of payment modes is associated with each user of the first set of users. The processor 110 is further configured to generate a first request that comprises the second set of identifiers of the second set of payment modes that is determined to be issued to the first set of users. The processor 110 is further configured to retrieve the second historical data associated with the first set of users from the open banking server 112.

Referring now to the open banking server 112, the open banking server 112 is a server arrangement that includes suitable logic, circuitry, interface, and/or code, executable by the circuitry, for facilitating secure communication with third-party service providers (e.g., the payment network that operates the rewards server 108) through the APIs. In an embodiment, details of the transaction history associated with the plurality of users (e.g., the first set of users) are stored as account profiles based on consent from each of the plurality of users. The account profiles may correspond to structured collection of financial data related to the plurality of users. The structured collection of financial data may include a type of account, transaction history, an account balance, the second set of payment modes, or the like. The open banking server 112 is operated by various issuers (e.g., the plurality of issuers).

Open banking may refer to the practice of financial institutions (e.g., the first issuer or the plurality of issuers) to securely share financial data (e.g., the transaction history, account balance, permanent account numbers, or the like) with third-party service providers through application programming interfaces (APIs) over secure communication channels. The financial data of the first set of users is shared based on prior consent received from each of the first set of users. In an embodiment, the open banking server 112 may correspond to an open banking platform that may provide the financial data of the first set of users to the processor 110 using APIs. Examples of the open banking platform may include Cashfree®, Plaid®, TrueLayer®, or the like.

For the sake of brevity, the system 100 is shown to include the open banking server 112. However, in various embodiments, the system 100 may include a plurality of open banking servers such that each of the plurality of open banking servers may be associated with the plurality of issuers. The open banking server 112 is configured to receive the first request from the processor 110. The first request may include the second set of identifiers of each of the second set of payment modes that is determined to be issued to the at least one of the first set of users. Upon receiving the first request, the open banking server 112 is further configured to provide the transaction history associated with the at least one of the second set of payment modes to the processor 110.

The transaction history associated with the at least one of the second set of payment modes may correspond to previous transactions that relate to the second set of payment modes associated with the first set of users. In an example, upon identifying that the first user 102 of the first set of users has reward points that are expiring after the first time period, the rewards server 108 determines that a third payment mode of the second set of payment modes and a fourth payment mode of the second set of payment modes are issued to the first user 102 by at least one of the plurality of issuers that are different from the first issuer. The third payment mode and the fourth payment mode may be the second credit card and the second debit card, respectively. Thus, the transaction history retrieved from the open banking server 112 for the first user 102 may include each transaction performed by the first user 102 by way of at least one of the second credit card and the second debit card. The transaction history associated with the second set of payment modes may be alternatively referred to as “second historical data”.

Referring back to the processor 110, the processor 110 is further configured to initiate an analysis of the transaction history (e.g., the first historical data and the second historical data) of the first set of users to detect at least one transaction of the transaction history that is associated with one of a set of sustainable initiatives for each of the first set of users. In an embodiment, the set of sustainable initiatives refers to any projects, services, organizations, or products that support environmental preservation and sustainability. Examples of the set of sustainable initiatives may include farming and agriculture, gardening and landscaping services, environmental services, renewable energy products and services, environmental and ecological organizations, recycling centers, green products and services, biofuels, or the like.

A transaction is detected to be associated with a sustainable initiative based on a link between the transaction and one of a plurality of transaction category codes in the transaction history of each of the first set of users. For example, details of the transaction include one of the plurality of transaction category codes. The plurality of transaction category codes may correspond to numeric identifiers to classify and categorize different types of transactions. The plurality of transaction category codes may be uniquely mapped with the set of sustainable initiatives. For example, farming and agriculture may have a transaction category code of 0742, gardening and landscaping services may have a transaction category code of 0780, and renewable energy products and services may have a transaction category code of 4911. The first memory 109 is configured to store the mapping between the plurality of transaction category codes and the set of sustainable initiatives. The first memory 109 may include a second tabular database or a second graphical database to store the mapping between the plurality of transaction category codes and the set of sustainable initiatives.

The processor 110 is further configured to determine whether one of the transactions of the transaction history is linked with one of the plurality of transaction category codes. The transaction history is detected to be associated with one of the set of sustainable initiatives when at least one transaction of the transaction history is linked with the one of the plurality of transaction category codes. In one embodiment, the rewards server 108 parallelly analyzes the transaction history associated with both first and second set of payment modes for the first set of users. For example, the first user 102 purchases solar panels utilizing at least one of the first set of payment modes (the first and second payment modes) and the second set of payment modes (the third and fourth payment modes) associated with the first user 102. Details of a transaction corresponding to the purchase of the solar panel may include the transaction category code of 4911. Thus, the rewards server 108 determines that the transaction with the transaction category of 4911 is associated with one of the set of sustainable initiatives.

In some embodiments, the processor 110 may initiate the analysis of the first historical data of the first set of users to detect at least one transaction of the first historical data that is associated with the set of sustainable initiatives. Upon a failure to identify a single transaction of the first historical data associated with the set of sustainable initiatives, the processor 110 may determine whether the second set of payment modes is issued to the first set of users. Further, the processor 110 may generate the first request that comprises the second set of identifiers of each of the second set of payment modes that is determined to be issued to the at least one of the first set of users. Based on the first request, the processor 110 may retrieve the second historical data from the open banking server 112. Further, the processor 110 may initiate an analysis of the second historical data of the first set of users to detect at least one transaction of the second historical data that is associated with the set of sustainable initiatives.

The processor 110 is further configured to select a second set of users from the first set of users such that the at least one transaction of the transaction history of the second set of users is detected to be associated with the set of sustainable initiatives. In an example, the second set of users may include two users that are selected from 10 users (e.g., the first set of users). The processor 110 is further configured to extract details of the reward points associated with the second set of users from the first memory 109. The details of the reward points may include at least one of a balance and the first time period associated with the reward points. In an example, the second set of users may include the first user 102 and a second user (not shown). The balance of the reward points available to the first user 102 may be 200 and the balance of the reward points available to the second user may be 500. Further, the first time period of the reward points available to both the first user 102 and the second user may be 10 days (e.g., the first time period).

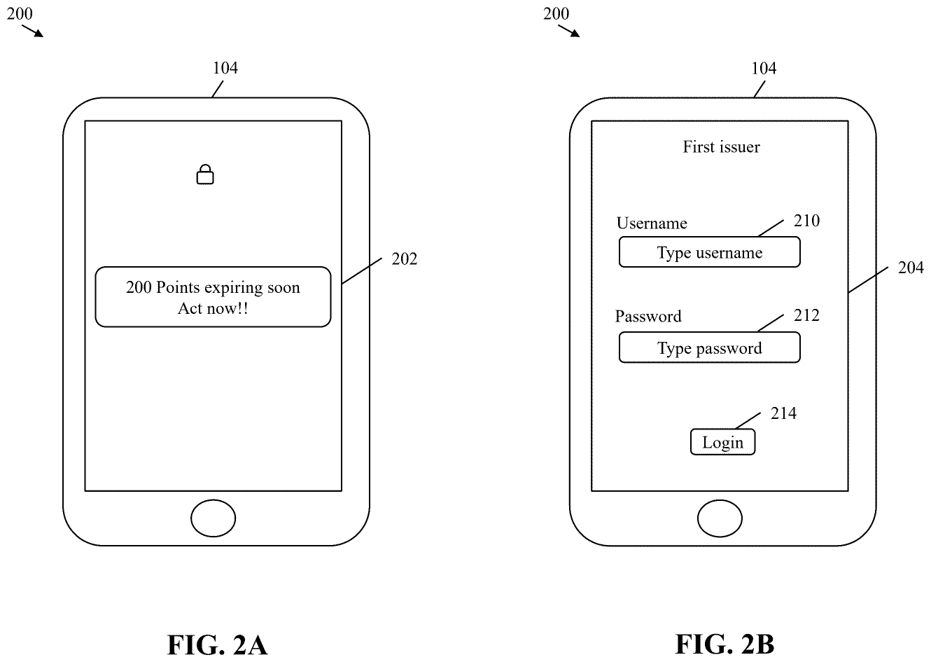

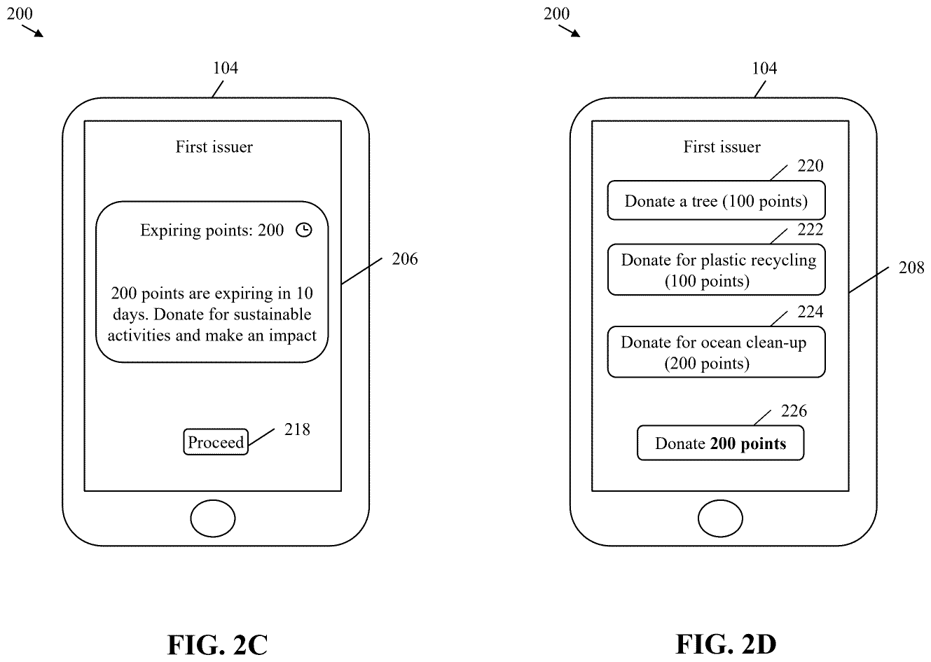

The processor 110 is further configured to generate a dataset of the second set of users that may include the details of the reward points that are set to expire for each of the second set of users and an identifier of each of the second set of users. Further, the processor 110 is configured to communicate the dataset of the second set of users to the first issuer server 106. In an embodiment, the second set of users has the service application 120 installed in a corresponding user device. Additionally, based on the communication of the dataset, the details of the reward points associated with the second set of users is notified on the corresponding user device by the first issuer server 106. For example, the first user 102 receives a notification (shown later in FIG. 2A) on the user device 104 indicating that 200 reward points are expiring in 10 days. Additionally, the second user receives a notification on a corresponding user device (such as a second user device) indicating that 500 reward points are expiring in 10 days. Further, the second set of users is notified to donate the reward points that are set to expire to at least one of a set of sustainable activities. For the sake of brevity, it is assumed that the set of sustainable activities refers to charitable initiatives that align with environmental, social, and governance (ESG) objectives. Examples of the set of sustainable activities may include environmental conservation, animal welfare, sustainable development, community development, or the like.

In one embodiment, the rewards server 108 may notify each of the second set of users on a corresponding user device to donate the reward points that are set to expire to the set of sustainable activities to gauge an interest of each of the second set of users to donate to such sustainable activities. The rewards server 108 awaits a response from each of the second set of users to confirm an interest to donate to the set of sustainable activities.

Although it is mentioned that the reward points are set to expire after the first time period, in some embodiments, the reward points may be set to expire within the first time period.

For the sake of brevity, operations for the first user 102 and the second user that correspond to the second set of users is explained in detail in in the foregoing description. However, in various other embodiments, interactions may occur between the rewards server 108 (e.g., the processor 110) and various other users of the second set of users.

The processor 110 is further configured to receive a first selection from the first issuer server 106. The processor 110 receives the first selection upon notifying (e.g., notify the second set of users) to donate the reward points. The first selection may be indicative of donating the reward points to the set of sustainable activities thereby confirming an interest from the second set of users to donate to the set of sustainable activities. The first selection may be indicative of donating the reward points in entirety (e.g., donate all the reward points) or partially (e.g., donate a subset of the reward points). In the above example, the first user 102 may select to donate 200 reward points to the set of sustainable activities. Further, the second user may select to donate 300 reward points out of the total 500 reward points to the set of sustainable activities. The second user may avail the remaining 200 reward points to activities other than the set of sustainable activities.

The processor 110 is further configured to fetch a list of the set of sustainable activities from the donation server 114. The processor 110 is further configured to associate upon receiving the first selection, the set of sustainable activities to the reward points. For example, the processor 110 may associate the set of sustainable activities with 200 reward points for the first user 102 such that each of the sustainable activities has a minimum donation equal to or less than 200 reward points. Additionally, the processor 110 may associate the set of sustainable activities with 300 reward points for the second user such that each of the sustainable activities has a minimum donation equal to or less than 300 reward points. In an embodiment, the rewards server 108 may be further configured to identify upcoming events related to the set of sustainable activities based on information from non-governmental organization (NGO) websites, social media, email newsletter, online communities, or the like. Upon identification of the upcoming events, the rewards server 108 may identify the requirement of reward points for each event related to the set of sustainable activities. Further, the rewards server 108 may associate the sustainable activities of the upcoming events to the reward points that are set to expire. For example, a tree plantation drive is scheduled after 7 days. Thus, each of the first user 102 and the second user may be notified to donate towards the tree plantation drive.

In some embodiments, the processor 110 may associate the set of sustainable activities with the transaction history of at least one of the second set of users. For example, when the transaction history of the first user 102 is indicative of regular transactions towards renewable energy products and services for environmental conservation or sustainable development (e.g., purchase of solar panels, electric vehicles, solar water heaters, or the like), the processor 110 may associate the set of sustainable activities with environmental conservation or sustainable development and communicate such sustainable activities to the first issuer server 106.

In some embodiments, the processor 110 may store previous donations to the set of sustainable activities by the second set of users as a preferred option in the first memory 109. The preferred option may be stored corresponding to the second set of users. Further, the processor 110 may associate the set of sustainable activities with the preferred option of at least one of the second set of users. For example, when the previous donation of the first user 102 is indicative of donation towards tree plantation, the processor 110 may store ‘tree plantation’ as the preferred option in the first memory 109. Further, the processor 110 may associate the set of sustainable activities with the preferred option and provide such sustainable activities to the second set of users by way of the first issuer server 106.

The processor 110 is further configured to provide at least one of the set of sustainable activities to the first issuer server 106 to receive a confirmation of donation of the reward points to the set of sustainable activities. Based on the association of the set of sustainable activities to the reward points, the processor 110 may provide the set of sustainable activities that are associated with available balance of the reward points to the first issuer server 106 for the second set of users. For example, when the first user 102 may select to donate 200 reward points, the processor 110 may provide the sustainable activities that have minimum donation equal to or less than 200 points (e.g., donate tree for 100 reward points, donate for plastic recycling for 100 points, donate for ocean clean-up activities for 200 reward points). Additionally, when the second user may select to donate 300 reward points, the processor 110 may provide the sustainable activities that have minimum donation equal to or less than 300 points (e.g., donate for plastic recycling 100 points, donate for coral reef restoration 100 points, donate for ocean clean up 200 points, or donate for E-waste recycling 300 points).

In various embodiments, the processor 110 may provide an option to auto-donate the reward points that are set to expire after the first time period to the second set of users on the corresponding user devices. For example, during registration, the second set of users may select preferences for the donation of the reward points on the service application 120 in the corresponding user device. Further, the second set of users may enable the option to auto-donate. The processor 110 may thus donate the reward points to at least one of the sustainable activities based on preferences of the second set of users.

The processor 110 is further configured to receive a confirmation to donate the reward points by the second set of users to the set of sustainable activities based on the sustainable activities displayed on corresponding user devices. For example, the processor 110 receives a confirmation from the first issuer server 106 to donate 200 reward points towards ocean cleanup based on the first selection by the first user 102. Further, the processor 110 receives a confirmation from the first issuer server 106 to donate 100 reward points towards coral reef restoration and 200 reward points towards ocean cleanup based on the first selection by the second user. Upon the reception of the confirmation, the processor 110 is further configured to generate a redemption request for the acquirer server 116, to redeem the reward points to be donated. The redemption request may correspond to a message sent to the acquirer server 116 to redeem the reward points to be donated. Further, the processor 110 is configured to receive a redemption response from the acquirer server 116. The redemption response may correspond to a message sent to the processor 110 indicating an outcome of the redemption of the reward points. The redemption response may be indicative of success or failure of the redemption of the reward points.

Upon detecting successful redemption, the processor 110 determines that the reward points have been successfully redeemed. Further, the processor 110 is configured to authorize donation of the reward points that are successfully redeemed to the set of sustainable activities. In the above example, upon receiving the confirmation from the first user 102 and the second user, the processor 110 generates a redemption request to process the redemption of each of the 200 reward points and 300 reward points. Further, the processor 110 receives a redemption response from the acquirer server 116. The processor 110 determines that the redemption response indicates successful redemption of 200 reward points and 300 reward points. The processor 110 may further authorize donation of the reward points that are successfully redeemed (e.g., 200 reward points towards ocean cleanup and 300 reward points towards E-waste recycling). Further, the balance of the reward points of each of the first user 102 and the second user may be updated based on the successful authorization for the donation.

The donation server 114 is a server arrangement that includes suitable logic, circuitry, interface, and/or code, executable by the circuitry, for communicating the set of sustainable activities to the processor 110. The donation server 114 may store the set of sustainable activities in a second memory associated with the donation server 114. In an embodiment, the donation server 114 may periodically communicate with a plurality of entities that are associated with the set of sustainable activities to maintain the second memory. Further, the donation server 114 may update the second memory periodically to add a new sustainable activity to the second memory or remove the set of sustainable activities from the second memory. For example, in a financial quarter, the donation server 114 may receive submissions from the NGOs for a proposal to raise fund for a river clean-up, Thus, the donation server 114 may update the second memory to add river clean-up as the new sustainable activity. Additionally, in the same financial quarter, the donation server 114 may receive updates from the NGOs that a funding goal associated with ocean clean-up is fully funded. Thus, the donation server 114 may update the second memory to remove ocean clean-up from the set of sustainable activities. The donation server 114 may be maintained by one of the payment network or the digital payment platform. Further, the rewards server 108, the donation server 114, and the communication network 118 may form a system of the system 100.

The acquirer server 116 is a server arrangement that includes suitable logic, circuitry, interface, and/or code, executable by the circuitry, for processing redemption and donation of the reward points. The acquirer server 116 is configured to receive the redemption request from the processor 110. The acquirer server 116 is further configured to process the reward points to be donated based on the received redemption request. In an embodiment, during the processing of the reward points, the acquirer server 116 may receive a number of the reward points to be donated. Further, the acquirer server 116 may verify the reception of the reward points. For example, when the redemption request is received for the donation of 200 reward points towards ocean cleanup and 300 reward points towards E-waste recycling, the acquirer server 116 may verify the reception of 200 reward points and 300 reward points, respectively. Based on the verification of the reception of the reward points, the acquirer server 116 is further configured to generate the redemption response. The redemption response may be indicative of successful redemption of the reward points when the reward points are verified to be received by the acquirer server 116. Alternatively, the redemption response may be indicative of failure of redemption of the reward points based on a failure of reception of the reward points by the acquirer server 116. Further, the acquirer server 116 is configured to communicate the redemption response to the processor 110. Upon authorization by the processor 110, the acquirer server 116 is further configured to process the donation. During the processing of the donation, the acquirer server 116 may credit the reward points to a financial account associated with a beneficiary of each of the set of sustainable activities. In an embodiment, the acquirer server 116 credits a transactional value associated with the reward points. For example, the processor 110 authorizes the donation of 200 reward points towards ocean cleanup and 300 reward points towards E-waste recycling to the acquirer server 116, and each reward point may be equivalent to twenty cents. Thus, the acquirer server 116 credits a sum of 20 dollars to a financial account associated with a beneficiary engaged in ocean clean-up and 30 dollars to a financial account associated with a beneficiary engaged in E-waste recycling.

In operation, the processor 110 (e.g., the rewards server 108) may provide options to the first issuer server 106 to configure the first time period and the second time period. The first issuer server 106 may further provide the first configuration value of the first time period and the second configuration value of the second time period to the processor 110. Further, the processor 110 may receive the first configuration value and the second configuration value. The processor 110 may further configure the first time period and the second time period based on the first configuration value and the second configuration value, respectively. The processor 110 may further identify the first set of users from the plurality of users based on the reward points associated with the first set of payment modes of the first set of users. The reward points may be set to expire after the first time period. The processor 110 may periodically initiate the identification of the first set of users based on the second time period.

Upon the identification of the first set of users, the processor 110 may further retrieve the first historical data associated with the first set of users from the first memory 109. The first historical data associated with the first set of users may correspond to previous transactions that relates to at least one payment mode of the first set of payment modes associated with the first set of users. Additionally, the processor 110 may determine whether the second set of payment modes is issued to the first set of users. Upon determining that the second set of payment modes is issued to the first set of users, the processor 110 may generate the first request. The first request may include the second set of identifiers of each of the second set of payment modes that is determined to be issued to the first set of users.

The processor 110 may further retrieve the second historical data associated with the first set of users from the open banking server 112. The second historical data associated with the first set of users may correspond to the previous transactions that relates to at least one of the second set of payment modes associated with the first set of users.

The processor 110 may further initiate the analysis of the transaction history (e.g., the first historical data and the second historical data) of the first set of users to detect at least one transaction of the transaction history that is associated with one of the set of sustainable initiatives. Upon determining that at least one transaction of the transaction history of the second set of users is associated with the set of sustainable initiatives, the processor 110 may select the second set of users from the first set of users. Further, the processor 110 may extract details of the reward points associated with the second set of users from the first memory 109. The details may include a balance and a first time period of the reward points. The processor 110 may further communicate the dataset of each of the second set of users to the first issuer server 106.

The second set of users is notified on the corresponding user devices. For the sake of simplicity of the ongoing description and without deviating from the scope of the disclosure, it is assumed that the first user 102 of the second set of users is notified on the user device 104 by the first issuer server 106 to donate the reward points that are set to expire to the set of sustainable activities. In an embodiment, the service application 120 may generate a notification to notify the first user 102 to donate the reward points that are set to expire to the set of sustainable activities.

The first user 102 may be associated with the financial account with the first issuer server 106. Further, the first user 102 may have user credentials to access the financial account. Upon receiving the notification, the first user 102 may click on the notification and may log in to the financial account with the user credentials. Upon login, the first issuer server 106 may provide the details of the reward points to the first user 102 on the user device 104. The first user 102 may select a donation option to donate the reward points to the set of sustainable activities. In an embodiment, the reward points may correspond to the total reward points that are available to the first user 102. For example, the first user 102 may choose to donate 200 reward points out of total 200 available reward points. In some embodiments, the reward points may correspond to a subset of the total reward points. For example, the first user 102 may choose to donate 100 reward points out of total 200 available reward points.

The user device 104 may provide the first selection to the first issuer server 106 based on the first selection of the donation option. The first issuer server 106 may further provide the first selection to the processor 110. Further, the processor 110 may associate the set of sustainable activities to the reward points that are set to expire for the first user 102. The processor 110 may further provide the set of sustainable activities to the first issuer server 106. Upon receiving the set of sustainable activities, the first issuer server 106 may provide an option to the first user 102 to select from the set of sustainable activities. Based on the selection, the user device 104 may provide the confirmation of donation to the first issuer server 106. Further, the first issuer server 106 may communicate the confirmation of donation to the processor 110.

The processor 110 may further generate the redemption request to process the reward points to be donated. Further, the processor 110 may communicate the redemption request to the acquirer server 116. Upon receiving the redemption request, the acquirer server 116 may redeem the reward points. The acquirer server 116 may further provide the redemption response. Further, the processor 110 may determine that the redemption response indicates successful redemption and the reward points have been successfully redeemed. Further, the acquirer server 116 may authorize donation of the reward points that are successfully redeemed to the set of sustainable activities. The acquirer server 116 may further process the donation of the reward points. Additionally, the acquirer server 116 may communicate a confirmation of the donation of the reward points to the processor 110.

FIGS. 2A-2D are schematic diagrams 200 that illustrate a first user interface (UI) screen 202, a second UI screen 204, a third UI screen 206, and a fourth UI screen 208, that are rendered on the user device 104, in accordance with an exemplary embodiment of the present disclosure. In a scenario, the first user 102 may have the service application 120 of the first issuer installed on the user device 104. Further, the first user 102 owns the first payment mode issued by the first issuer. In an example, 200 reward points of the first payment mode are set to expire within 10 days.

Referring now to FIG. 2A, the user device 104 renders the first UI screen 202. The service application 120 displays the notification “200 reward points expiring soon. Act now !!” for the first user 102 based on the notification received by the user device 104 from the first issuer. Upon receiving the notification, the first user 102 may click on the notification. Upon clicking on the notification, the user device 104 renders the second UI screen 204.

Referring now to FIG. 2B, the second UI screen 204 prompts the first user 102 to enter a username and a password by way of a first field 210 and a second field 212, respectively. Thus, the first field 210 displays “Type username” and the second field 212 displays “Type password”. The second UI screen 204 further includes a login button 214. The first user 102 may enter the username in the first field 210 and the password in the second field 212 and click on the login button 214. The username and password of the first user 102 are thus provided by the user device 104 to the first issuer server 106. The first issuer server 106 authenticates the first user 102 based on stored authentication information (such as comparing the received username and password with stored username and password). The first issuer server 106 transmits the authentication response that includes a result of the authentication to the user device 104. When the authentication is a failure, the user device 104 may display a message, indicating an authentication failure. Alternatively, when the authentication is successful, the user device 104 renders the third UI screen 206.

Referring now to FIG. 2C, the third UI screen 206 displays the reward points that are set to expire and notifies the first user 102 to donate the reward points to sustainable activities. Thus, the third UI screen 206 displays, “Expiring points: 200”. The third UI screen 206 further displays, “200 points are expiring in 10 days. Donate for sustainable activities and make an impact”. The third UI screen 206 further includes a proceed button 218. The proceed button 218 may be associated with redemption of the reward points that are set to expire after the first time period (e.g., after ten days). The first user 102 may select the proceed button 218 to redeem the reward points that are set to expire after the first time period. The selection of the proceed button 218 indicating the redemption of the reward points may correspond to the first selection. The first issuer server 106 may communicate the first selection to the rewards server 108. The rewards server 108 may associate the sustainable activities to the reward points (e.g., 200 reward points) that are set to expire. The rewards server 108 may provide the sustainable activities to the first issuer server 106. Further, the first issuer server 106 may provide options to select the sustainable activities to the user device 104 by way of the fourth UI screen 208 rendered on the user device 104. For the sake of simplicity of the ongoing description, the third UI screen 206 is not shown to include an option to select the reward points.

Referring now to FIG. 2D, the fourth UI screen 208 displays the sustainable activities associated with the reward points that are set to expire after the first time period. For example, when 200 reward points are set to expire after the first time period, the fourth UI screen 208 may include the sustainable activities that allow donations below or equal to 200 reward points. On the fourth UI screen 208, the first user 102 is presented with options to select at least one of the sustainable activities to donate the reward points. The fourth UI screen 208 includes a first selectable option 220, a second selectable option 222, and a third selectable option 224 for the first user 102. The first selectable option 220, the second selectable option 222, and the third selectable option 224 indicate “Donate a tree (100 points), donate for plastic recycling, and ”Donate for ocean clean-up (200 points). In one example, the first user 102 may select the first selectable option 220 for donating 100 reward points and the second selectable option 222 for donating 100 reward points. In another example, the first user 102 may select the third selectable option 224 for donating 200 reward points. The fourth UI screen 208 further includes a donate button 226. In an example, based on the selection of the first selectable option 220 and the second selectable option, the donate button 226 may display a total number of the reward points to be donated (e.g., 200 reward points). Further, the first user 102 clicks on the donate button 226 (e.g., “Donate 200 points”) to donate the 200 reward points. The first user 102 thus donates the 200 reward points towards sustainable activities (e.g., donation of tree and plastic recycling). Upon successful donation, the first user 102 may receive a confirmation on the user device 104 indicating the successful donation of the reward points to the sustainable activities. In addition, the first user 102 may receive a message indicating the updated balance of the reward points on the user device 104.

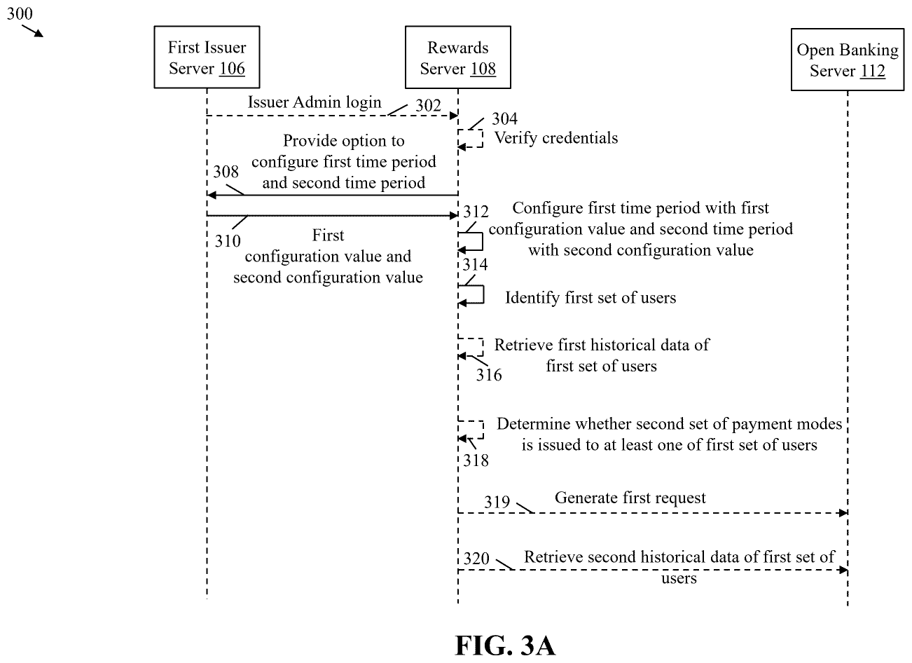

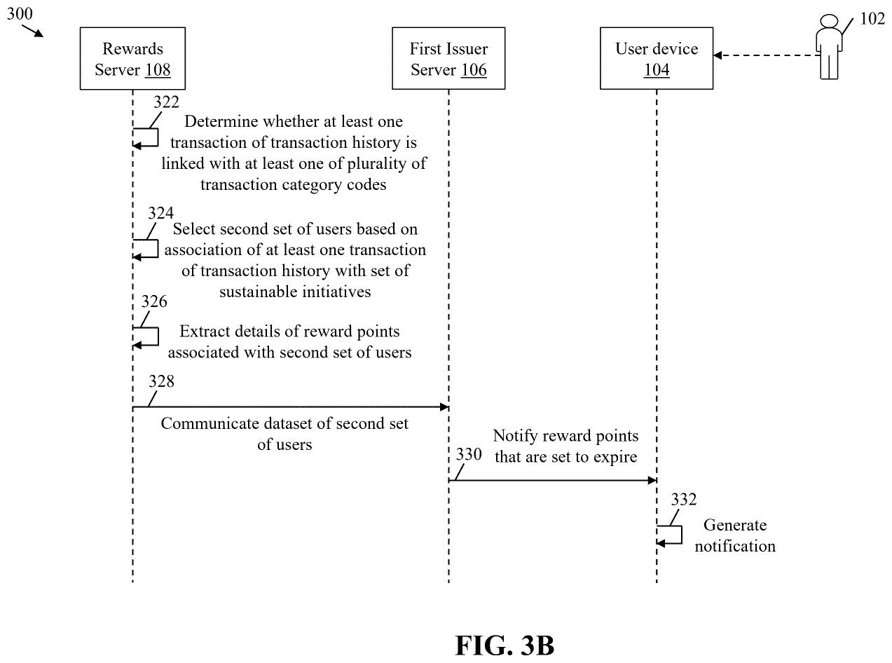

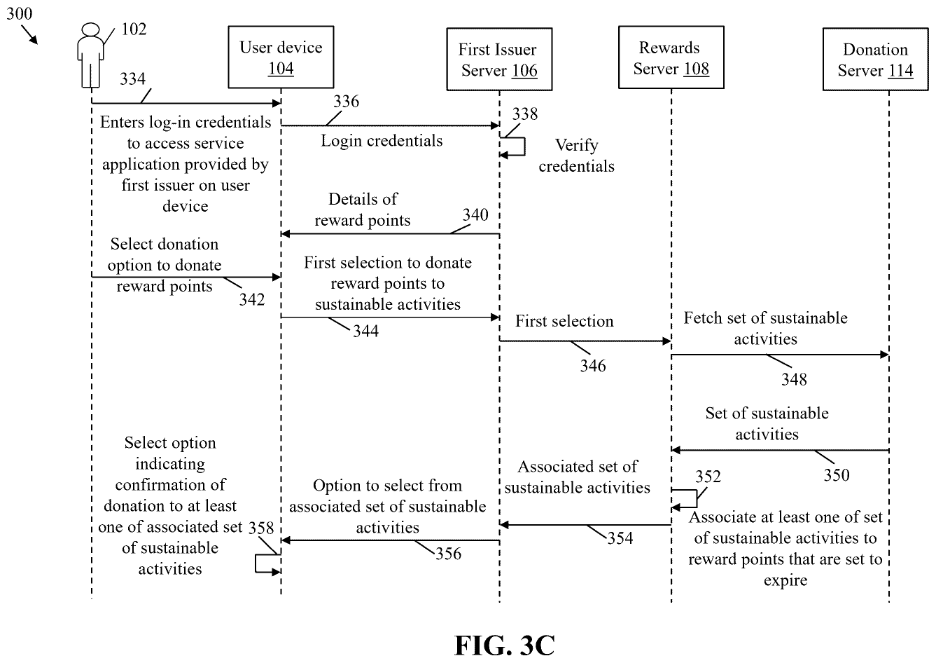

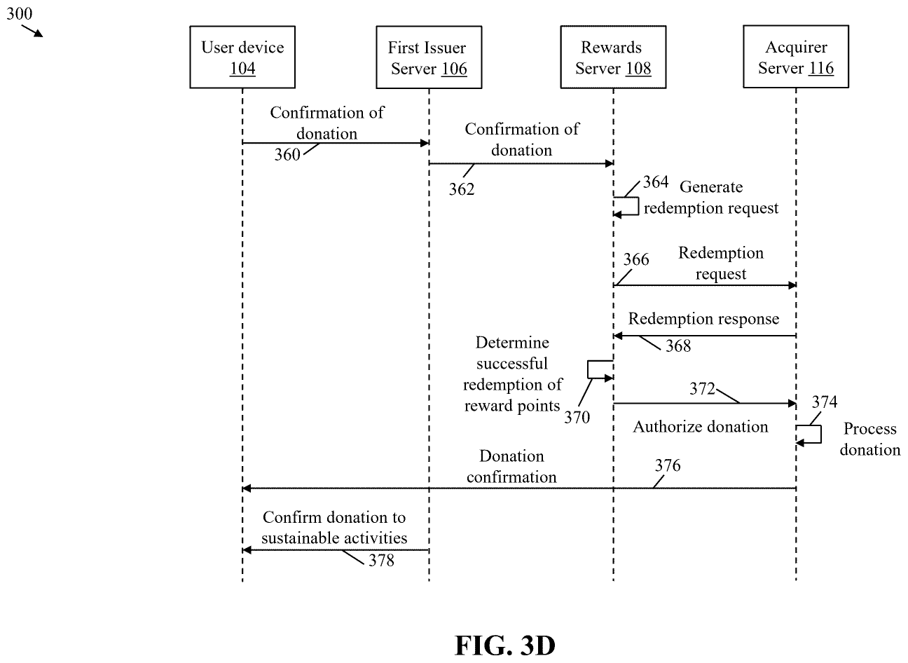

FIGS. 3A-3D collectively represent a process flow diagram 300 that illustrates an exemplary method of facilitating utilization of the reward points by the system 100, in accordance with an embodiment of the present disclosure.

Referring to FIG. 3A, in an embodiment, the issuer admin may log in (e.g., log in through the first issuer server 106) to the admin account with the admin credentials (as shown by dotted arrow 302). Upon receiving the admin credentials, the rewards server 108 may verify the admin credentials based on stored admin credentials (as shown by dotted arrow 304). Upon successful verification, the rewards server 108 may provide options to the issuer admin to configure the first time period and the second time period (as shown by solid arrow 308). Further, the rewards server 108 may receive the first configuration value and the second configuration value (as shown by solid arrow 310). The rewards server 108 may further configure the first time period and the second time period based on the first configuration value and the second configuration value, respectively (as shown by solid arrow 312).

The rewards server 108 may further identify the first set of users from the plurality of users based on the reward points associated with the first set of payment modes of each of the plurality of users (as shown by solid arrow 314). The identification may be based on the reward points of the first set of users such that the reward points may expire after the first time period. The second configuration value may indicate a time interval to periodically initiate the identification of the first set of users based on the first time period by the rewards server 108. In an embodiment, the rewards server 108 may further retrieve the first historical data associated with each of the first set of users (as shown by dotted arrow 316). Further, the rewards server 108 may determine whether the second set of payment modes is issued to the first user 102 (as shown by dotted arrow 318). The rewards server 108 may generate the first request (as shown by dotted arrow 319). The first request may include the second set of identifiers for the second set of payment modes that is determined to be issued to the first set of users. Further, the rewards server 108 may retrieve the second historical data of the first set of users from the open banking server 112 (as shown by dotted arrow 320).

In some embodiments, upon identifying the second set of users, the rewards server 108 may determine whether the second set of payment modes is issued to the first user 102 (as shown by dotted arrow 318). The rewards server 108 may generate the first request (as shown by dotted arrow 319). The first request may include the second set of identifiers for the second set of payment modes that is determined to be issued to the first set of users. Further, the rewards server 108 may retrieve the second historical data of the first set of users from the open banking server 112 (as shown by dotted arrow 320).

Now, referring to FIG. 3B, the rewards server 108 may further determine whether the at least one transaction of the transaction history (e.g., the first historical data and the second historical data) of the first set of users is linked with the at least one of the plurality of transaction category codes (as shown by solid arrow 322). Further, based on the determination that the at least one transaction of the transaction history is linked with the at least one of plurality of transaction category codes, the rewards server 108 may further detect that the at least one transaction of the transaction history is associated with the set of sustainable initiatives.

The rewards server 108 may select the second set of users (e.g., select the second set of users from the first set of users) based on the association of the at least one transaction of the transaction history with the set of sustainable initiatives (as shown by solid arrow 324). Further, the rewards server 108 may extract the details of the reward points associated with the second set of users from the database associated with the rewards server 108 (as shown by solid arrow 326). The details may include the balance and the first time period of the reward points. The rewards server 108 may further generate the dataset of each of the second set of users that may include the details of the reward points that are set to expire for the second set of users and the identifier of each of the second set of users. Further, the rewards server 108 may communicate the dataset of each of the second set of users to the first issuer server 106 (as shown by solid arrow 328).

For sake of simplicity of the ongoing description and without deviating from the scope of the disclosure, it is assumed that the first issuer server 106 may notify the first user 102 on the user device 104 to donate the reward points that are set to expire to the set of sustainable activities (as shown by solid arrow 330). Additionally, the service application 120 of the user device 104 may generate the notification to notify the first user 102 to donate the reward points that are set to expire to the set of sustainable activities (as shown by solid arrow 332).

Now, referring to FIG. 3C, upon receiving the notification, the first user 102 may click on the notification and may enter log-in credentials to access the service application 120 provided by the first issuer server 106 on the user device 104 (as shown by solid arrow 334). The user device 104 may further provide the log-in credentials to the first issuer server 106 (as shown by solid arrow 336). Upon receiving the log-in credentials, the first issuer server 106 may verify the log-in credentials based on stored log-in credentials (as shown by solid arrow 338) to authenticate the first user 102. Further, the first issuer server 106 may provide the details of the reward points to the first user 102 on the user device 104 (as shown by solid arrow 340). The first user 102 may select the donation option to donate the reward points towards sustainable activities (as shown by solid arrow 342). In an embodiment, the reward points may correspond to the total reward points that are available to the first user 102. For example, the first user 102 may choose to donate all the 200 reward points. In another embodiment, the reward points may correspond to a subset of the total reward points. For example, the first user 102 may choose to donate 100 reward points out of total 200 available reward points.

The user device 104 may provide the first selection to the first issuer server 106 to donate the reward points towards at least one of the set of sustainable activities (as shown by solid arrow 344). The first issuer server 106 may further communicate the first selection to the rewards server 108 (as shown by solid arrow 346). Further, the rewards server 108 may fetch the set of sustainable activities from the donation server 114 (as shown by solid arrow 348). The donation server 114 may provide the set of sustainable activities to the rewards server 108 (as shown by solid arrow 350). Further, the rewards server 108 may associate the set of sustainable activities to the reward points that are set to expire for the first user 102 (as shown by solid arrow 352). The rewards server 108 may further provide the associated set of sustainable activities to the first issuer server 106 (as shown by solid arrow 354). Upon receiving the associated set of sustainable activities, the first issuer server 106 may provide the option to the first user 102 to select from the associated set of sustainable activities (as shown by solid arrow 356). Further, the user device 104 may select the option indicating the confirmation to donate to at least one of the associated set of sustainable activities (as shown by solid arrow 358).

Now, referring to FIG. 3D, based on the selection, the user device 104 may provide the confirmation of donation to the first issuer server 106 (as shown by solid arrow 360). Further, the first issuer server 106 may communicate the confirmation of donation to the rewards server 108 (as shown by solid arrow 362).

The rewards server 108 may further generate the redemption request to process the reward points to be donated (as shown by solid arrow 364). Further, the rewards server 108 may communicate the redemption request to the acquirer server 116 to redeem the reward points to be donated (as shown by solid arrow 366). The acquirer server 116 may process the redemption request. The acquirer server 116 may further provide the redemption response to the rewards server 108 (as shown by solid arrow 368). Based on the redemption response, the rewards server 108 may determine that the reward points have been successfully redeemed by the acquirer server 116 (as shown by solid arrow 370). Further, the acquirer server 116 may authorize donation of the reward points that are successfully redeemed to the set of sustainable activities (e.g., as shown by solid arrow 372). The acquirer server 116 may further process the donation of the reward points (as shown by solid arrow 374). Further, the acquirer server 116 may communicate the confirmation of the donation of the reward points to the user device 104 (as shown by solid arrow 376). Additionally, the first issuer server 106 may provide the confirmation of the donation of the reward points towards the set of sustainable activities to the user device 104 (as shown by solid arrow 378).

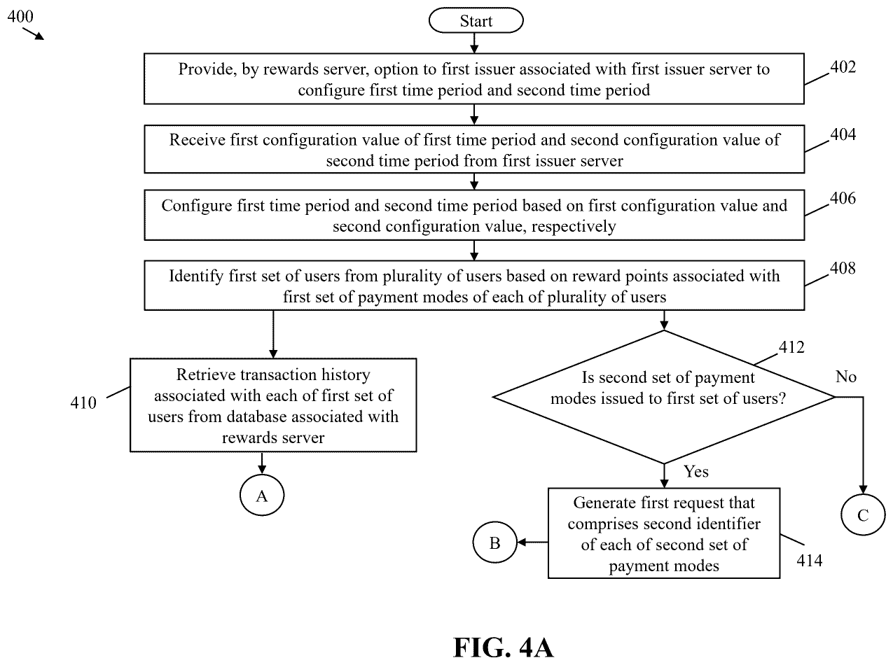

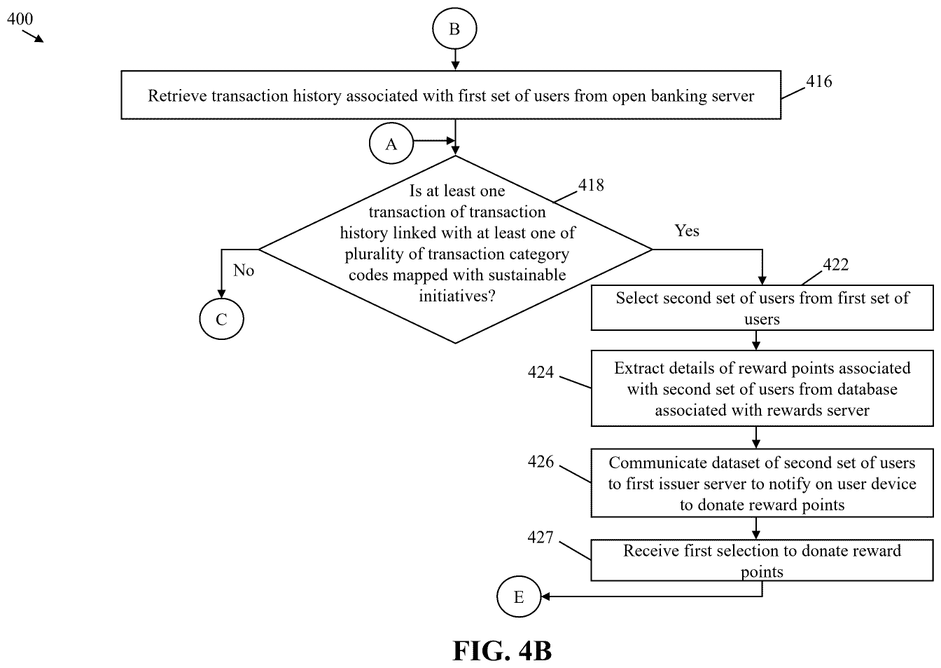

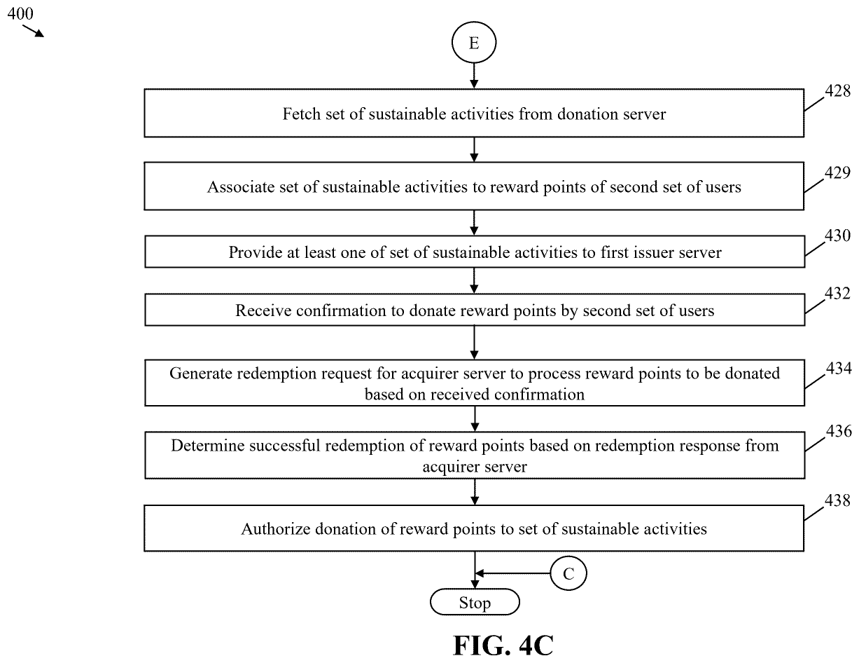

FIGS. 4A-4C, collectively, represent a flow chart 400 that illustrates the method for facilitating utilization of the reward points by the rewards server 108, in accordance with an exemplary embodiment of the present disclosure.

Referring to FIG. 4A, the process may start at step 402. At step 402, the rewards server 108 may provide options to the first issuer server 106 to configure the first time period and the second time period. At step 404, the rewards server 108 may receive the first configuration value of the first time period and the second configuration value of the second time period, from the first issuer server 106. At step 406, the rewards server 108 may further configure the first time period and the second time period based on the first configuration value and the second configuration value, respectively. At step 408, the rewards server 108 may further identify the first set of users from the plurality of users based on the reward points associated with the first set of payment modes of each of the plurality of users. For the sake of simplicity of the ongoing description, it is assumed that after step 408, step 410 and steps 412-416 are executed. At step 410, the rewards server 108 may further retrieve the transaction history associated with each of the first set of users from the database (e.g., the first memory 109) associated with the rewards server 108. At step 412, the rewards server 108 may further determine whether the second set of payment modes is issued to the first set of users. If at step 412, it is determined that the second set of payment modes is issued to the first set of users, step 414 is performed. At step 414, the rewards server 108 may generate the first request that may comprise the second identifier for each of the second set of payment modes. If at step 412, it is determined that the second set of payment modes are unavailable to the first set of users, the process comes to a halt.

Referring to FIG. 4B, at step 416, the rewards server 108 may retrieve the transaction history associated with the first set of users from the open banking server 112. Step 418 is performed after step 416 and step 410. At step 418, the rewards server 108 may further determine whether the at least one transaction of the transaction history is linked with at least one of the plurality of transaction category codes that is mapped with the set of sustainable initiatives. If at step 418, it is determined that the at least one transaction of the transaction history is unlinked with one of the plurality of transaction category codes (e.g., a link with one of the plurality of transaction category codes is missing), the process comes to a halt.

If at step 418, it is determined that at least one transaction of the transaction history is linked with the set of sustainable initiatives, step 422 is performed. At step 422, the rewards server 108 may select the second set of users from the first set of users. At step 424, the rewards server 108 may extract details of the reward points associated with the second set of users from the database. At step 426, the rewards server 108 may further communicate the dataset of the each of the second set of users to the first issuer server 106. The dataset of the second set of users may include the details (e.g., the balance and the first time period) of the reward points that are set to expire and the identifier of the second set of users. The first issuer server 106 may notify the second set of users to donate the reward points that are set to expire after the first time period. At step 427, the rewards server 108 may receive the first selection to donate the reward points. It is assumed for the sake of simplicity of the ongoing description that the second set of users corresponds to the first user 102. It is further assumed that the first user 102 selects to donate all the reward points to the set of sustainable activities. The first selection may be provided by the first issuer server 106 based on the selection of the donation option on the user device 104 by the first user 102.

Referring to FIG. 4C, at step 428, the rewards server 108 may fetch the set of sustainable activities from the donation server 114. At step 429, the rewards server 108 may associate the set of sustainable activities to the reward points of the second set of users. In an example, the rewards server 108 may associated one or more sustainable activities to the reward points that are set to expire for the first user 102. At step 430, the rewards server 108 may provide the set of sustainable activities to the first issuer server 106. At step 432, the rewards server 108 may receive the confirmation to donate the reward points by the second set of users. At step 434, the rewards server 108 may further generate the redemption request for the acquirer server 116 to process the reward points to be donated based on the received confirmation. At step 436, the rewards server 108 may determine successful redemption of the reward points based on the redemption response received from the acquirer server 116. At step 438, the rewards server 108 may authorize the donation of the reward points to the set of sustainable activities.

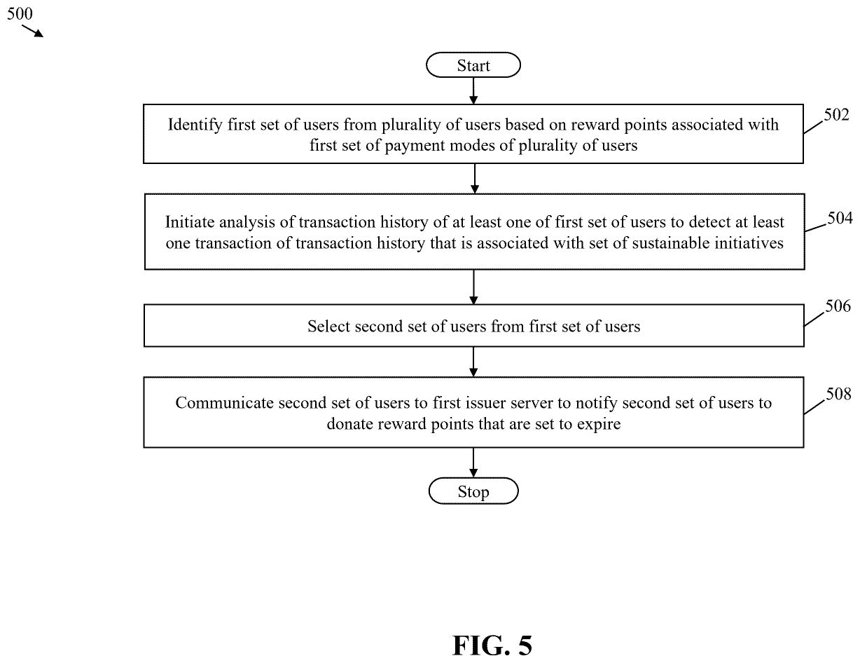

FIG. 5 represents a high-level flow chart 500 that illustrates a method (or process) for facilitating utilization of the reward points by the rewards server 108, in accordance with an exemplary embodiment of the present disclosure.

At step 502, the rewards server 108 identifies the first set of users from the plurality of users based on the reward points associated with the first set of payment modes of the plurality of users. The first set of payment modes is associated with the plurality of users. The reward points associated with each of the first set of users are set to expire after the first time period. At step 504, the rewards server 108 initiates the analysis of the transaction history of at least one of the first set of users to detect that at least one transaction of the transaction history of the at least one of the first set of users is associated with a set of sustainable initiatives.

At step 506, the rewards server 108 selects the second set of users from the first set of users. The second set of users is selected when at least one transaction of the transaction history of each of the second set of users is detected to be associated with the set of sustainable initiatives. At step 508, the rewards server 108 communicates the dataset of the second set of users to the first issuer server 106 associated with the first issuer such that each of the second set of users is notified on the corresponding user device by the first issuer server 106 to donate the reward points that are set to expire to the set of sustainable activities.

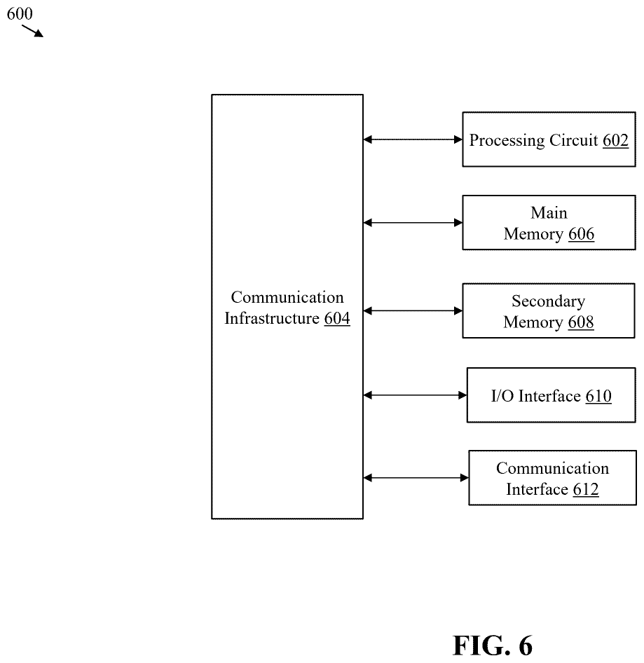

FIG. 6 is a block diagram that illustrates system architecture of a computer system 600, in accordance with an embodiment of the present disclosure. An embodiment of the present disclosure, or portions thereof, may be implemented as computer-readable code on the computer system 600. In one example, the first issuer server 106, the rewards server 108, the open banking server 112, the donation server 114, and the acquirer server 116 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of 4A-4C and 5.

The computer system 600 includes a processing circuit 602 that may be a special purpose or a general-purpose processing device. The processing circuit 602 may be a single processor, multiple processors, or combinations thereof. The processing circuit 602 may have one or more processor “cores.” Further, the processing circuit 602 may be connected to a communication infrastructure 604, such as a bus, a bridge, a message queue, the communication network 118, multi-core message-passing scheme, and the like. The computer system 600 further includes a main memory 606 and a secondary memory 608. Examples of the main memory 606 may include RAM, ROM, and the like. The secondary memory 608 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art.

The computer system 600 further includes an I/O interface 610 and a communication interface 612. The I/O interface 610 includes various input and output devices that are configured to communicate with the processing circuit 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communications port, and the like. Data transferred via the communication interface 612 may be signals, such as electronic, electromagnetic, optical, or other signals as will be apparent to a person skilled in the art. The signals may travel via a communications channel, such as the communication network 118 which may be configured to transmit the signals to the various devices that are communicatively coupled to the computer system 600. Examples of the communication channel may include, but are not limited to, a cable, fiber optics, a phone line, a cellular phone link, a radio frequency link, a wireless link, and the like.

Computer program medium and computer usable medium may refer to memories, such as the main memory 606 and the secondary memory 608, which may be a semiconductor memory such as dynamic RAMs. These computer program mediums may provide data that enables the computer system 600 to implement the method illustrated in FIGS. 4A-4C and FIG. 5. In an embodiment, the present disclosure is implemented using a computer implemented application. The computer implemented application may be stored in a computer program product and loaded into the computer system 600 using the removable storage drive or the hard disc drive in the secondary memory 608, the I/O interface 610, or the communication interface 612.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processing circuit 602, and a memory unit, such as the main memory 606 and the secondary memory 608, implement the described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Embodiments in the present disclosure provide the system 100 and method for facilitating the utilization of the reward points associated with one of the first set of payment modes of each of the second set of users. The present disclosure presents a solution to the persistent issue of unused and expiring reward points by leveraging the transaction history of each of the first set of users to identify the second set of users that are interested in donating towards at least one of the sustainable initiatives. Based on the identification of the second set of users, targeted notifications can be delivered on corresponding user devices to notify each of the second set of users to donate the expiring reward points. Further, based on an assessment of the transaction history, each of the second set of users is associated with at least one of the sustainable activities that align with preferences of the second set of users, thereby increasing chances of donating towards the sustainable activity. Additionally, various identification techniques may assist in associating the second set of users with at least one of the sustainable activities that require urgent donations. Hence, the present disclosure provides a convenient and seamless solution facilitating utilization of reward points by the rewards server 108 to ensure simplicity and ease of implementation.

Techniques consistent with the present disclosure provide, among other features, systems, and methods for facilitating utilization of the reward points.

In the claims, the words ‘comprising’, ‘including’, and ‘having’ does not exclude the presence of other elements or steps than those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures may not be used to advantage.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

1. A computerized rewards points redemption method comprising:
providing, to each of a plurality of users who each have rewards points, a service application for installation on a respective one of a plurality of corresponding user devices;
identifying, by a rewards server, from the plurality of users who each have rewards points, a targeted set of users and, for each targeted user of the targeted set of users, rewards points to be donated;
causing, by the rewards server, the service application of each user of the targeted set of users to present, on a corresponding user device of the plurality of corresponding user devices, a notification to donate the identified rewards points of each user to at least one of a set of sustainable activities that are associated with a set of sustainable initiatives;
causing, by the service application of each user of the targeted set of users, the corresponding user device of the plurality of corresponding user devices to present a user interface configured to receive a confirmation to donate to one or more of the set of sustainable activities,
wherein identifying, by the rewards server, the targeted set of users and, for each targeted user of the targeted set of users, rewards points to be donated comprises:
identifying, by the rewards server, a first set of users from the plurality of users based on rewards points associated with a first set of payment modes, wherein the first set of payment modes is associated with the plurality of users, and wherein the rewards points associated with each respective one of the first set of users are set to expire after a first time period;
initiating, by the rewards server, an analysis of a transaction history of at least one of the first set of users to detect that at least one transaction of the transaction history of the at least one of the first set of users is associated with the set of sustainable initiatives; and
selecting as the targeted set of users, by the rewards server, a second set of users from the first set of users, wherein the at least one transaction of the transaction history of each of the second set of users is detected to be associated with the set of sustainable initiatives;
wherein causing, by the rewards server, the service application of each user of the targeted set of users to present, on the corresponding user device of the plurality of corresponding user devices, the notification to donate the identified rewards points of each user to at least one of the set of sustainable activities that are associated with the set of sustainable initiatives comprises:
communicating, by the rewards server, a dataset of the second set of users to a first issuer server such that each of the second set of users is notified on the corresponding user device by the first issuer server to donate the rewards points that are set to expire to at least one of a set of sustainable activities that are associated with the set of sustainable initiatives.

2. The method of claim 1, further comprising:
receiving, by the rewards server, a first configuration value of the first time period and a second configuration value of a second time period from the first issuer server, wherein the second configuration value indicates a time interval to periodically initiate the identification of the first set of users based on the first time period; and
configuring, by the rewards server, the first time period and the second time period based on the first configuration value and the second configuration value, respectively, wherein the first time period is configured with the first configuration value to identify the first set of users.

3. The method of claim 1, further comprising retrieving upon identifying the first set of users, by the rewards server, the transaction history associated with each of the first set of users from a database associated with the rewards server based on a first set of identifiers associated with the first set of payment modes associated with each of the first set of users to initiate the analysis of the transaction history.

4. The method of claim 1, further comprising:
determining upon identifying the first set of users, by the rewards server, whether a second set of payment modes is issued to the first set of users, wherein the second set of payment modes is associated with a plurality of issuers that are different from a first issuer associated with the first issuer server, and wherein the first set of payment modes is associated with the first issuer;
generating, by the rewards server, a first request that comprises a second set of identifiers associated with the second set of payment modes that is determined to be issued to the first set of users; and
retrieving, by the rewards server, based on the first request, the transaction history associated with the at least one of the first set of users from an open banking server to initiate the analysis of the transaction history.
wherein the transaction history of the at least one of the first set of users comprises:
a first transaction history of the first set of payment modes; and
the transaction history associated with the at least one of the first set of users that was retrieved by the rewards server from the open banking server.

5. The method of claim 1, further comprising determining to analyze the transaction history of each of the first set of users, by the rewards server, whether the at least one transaction of the transaction history of the at least one of the first set of users is linked with a transaction category code of a plurality of transaction category codes, wherein the plurality of transaction category codes are mapped with the set of sustainable initiatives, and wherein when the at least one transaction of the transaction history is determined to be linked with the transaction category code, the at least one transaction of the transaction history is detected to be associated with the set of sustainable initiatives.

6. The method of claim 1, further comprising extracting based on the selection of the second set of users, by the rewards server, details of the rewards points associated with at least one of the second set of users from a database associated with the rewards server, wherein the details of the rewards points include a balance and the first time period of the rewards points, and wherein the dataset of the second set of users includes the details of the rewards points that are set to expire for each of the second set of users and an identifier of each of the second set of users.

7. The method of claim 6, further comprising:
receiving upon notifying to donate the rewards points, by the rewards server, a first selection to donate the rewards points to at least one of the set of sustainable activities from the first issuer server, wherein the first selection is associated with at least one of the second set of users;
associating upon receiving the first selection, by the rewards server, the at least one of the set of sustainable activities to the rewards points that are set to expire for the at least one of the second set of users; and
providing, by the rewards server, at least one of the set of sustainable activities to the first issuer server to receive a confirmation of donation of the rewards points to the set of sustainable activities.

8. The method of claim 1, further comprising:
generating, by the rewards server and associated with the notification, a redemption request for an acquirer server to redeem, by at least one of the targeted set of users, one or more of the identified rewards points of the at least one of the targeted set of users based on the confirmation to donate, to one or more of the set of sustainable activities, the one or more of the identified rewards points;
determining, by the rewards server, that the one or more of the identified rewards points have been successfully redeemed based on a redemption response from the acquirer server; and
authorizing, by the rewards server, donation of the one or more of the identified rewards points that are successfully redeemed to the one or more of the set of sustainable activities based on the determination of successful redemption.

9. The method of claim 1, wherein the rewards points correspond to one of cashback points, loyalty points, gift coupons, and bonuses.

10. The method of claim 1, wherein the set of sustainable activities corresponds to at least one of environmental conservation, animal welfare, sustainable development, or community development.

11. The method of claim 1, wherein the set of sustainable initiatives corresponds to at least one of farming and agriculture, gardening and landscaping services, environmental services, renewable energy products and services, environmental and ecological organizations, recycling centers, green products and services, and biofuels.

12. A computerized rewards points redemption system comprising:
an interface for communicating with a first issuer server;
a rewards server; and
a service application for provision to each of a plurality of users who each have rewards points and for installation on a respective one of a plurality of corresponding user devices,
wherein the rewards server is configured to:
identify, from the plurality of users who each have rewards points, a targeted set of users and, for each targeted user of the targeted set of users, rewards points to be donated;
cause the service application of each user of the targeted set of users to present, on a corresponding user device of the plurality of corresponding user devices, a notification to donate the identified rewards points of each user to at least one of a set of sustainable activities that are associated with a set of sustainable initiatives;
cause, by the service application of each user of the targeted set of users, the corresponding user device of the plurality of corresponding user devices to present a user interface configured to receive a confirmation to donate to one or more of the set of sustainable activities,
wherein the rewards server being configured to identify the targeted set of users and. for each targeted user of the targeted set of users, rewards points to be donated comprises the rewards server being configured to:
identify a first set of users from the plurality of users based on rewards points associated with a first set of payment modes, wherein the first set of payment modes is associated with the plurality of users, and wherein the rewards points associated with each respective one of the first set of users are set to expire after a first time period;
initiate an analysis of a transaction history of at least one of the first set of users to detect that at least one transaction of the transaction history of the at least one of the first set of users is associated with the set of sustainable initiatives; and
select as the targeted set of users, a second set of users from the first set of users, wherein the at least one transaction of the transaction history of each of the second set of users is detected to be associated with the set of sustainable initiatives;
the rewards server being configured to cause the service application of each user of the targeted set of users to present, on the corresponding user device of the plurality of corresponding user devices, the notification to donate the identified rewards points of each user to at least one of the set of sustainable activities that are associated with the set of sustainable initiatives comprises the rewards server being configured to:
communicate a dataset of the second set of users to the first issuer server such that each of the second set of users is notified on the corresponding user device by the first issuer server to donate the rewards points that are set to expire to at least one of a set of sustainable activities that are associated with the set of sustainable initiatives.

13. The system of claim 12, wherein the rewards server is further configured to:
receive a first configuration value of the first time period and a second configuration value of a second time period from the first issuer server, wherein the second configuration value indicates a time interval to periodically initiate the identification of the first set of users based on the first time period; and
configure the first time period and the second time period based on the first configuration value and the second configuration value, respectively, wherein the first time period is configured with the first configuration value to identify the first set of users.

14. The system of claim 12, wherein the rewards server comprises a memory, wherein the memory is configured to store the transaction history associated with the first set of payment modes, and wherein the transaction history is stored for each of the first set of users.

15. The system of claim 12, wherein the rewards server is further configured to:
determine upon identifying the first set of users, whether a second set of payment modes is issued to the first set of users, wherein the second set of payment modes is associated with a plurality of issuers that are different from a first issuer associated with the first issuer server, and wherein the first set of payment modes is associated with the first issuer;
generate, a first request that comprises a second set of identifiers associated with the second set of payment modes that is determined to be issued to the first set of users; and
retrieve the transaction history associated with the at least one of the first set of users from an open banking server based on the first request, wherein the transaction history is retrieved to initiate the analysis of the transaction history.
wherein the transaction history of the at least one of the first set of users comprises:
a first transaction history of the first set of payment modes; and
the transaction history associated with the at least one of the first set of users that was retrieved by the rewards server from the open banking server.

16. The system of claim 12, wherein to analyze the transaction history of each of the first set of users, the rewards server is further configured to determine whether the at least one transaction of the transaction history of the at least one of the first set of users is linked with a transaction category code of a plurality of transaction category codes, wherein the plurality of transaction category codes are mapped with the set of sustainable initiatives, and wherein when the at least one transaction of the transaction history is determined to be linked with the transaction category code, the at least one transaction of the transaction history is detected to be associated with the set of sustainable initiatives.

17. The system of claim 12, wherein the dataset of the second set of users includes details of the rewards points that are set to expire for each of the second set of users, and an identifier of each of the second set of users, and wherein the details of the rewards points include a balance and the first time period of the rewards points.

18. The system of claim 17, wherein the rewards server is further configured to:
receive upon notifying to donate the rewards points, a first selection to donate the rewards points to at least one of the set of sustainable activities from the first issuer server, wherein the first selection is associated with at least one of the second set of users;
associate upon receiving the first selection, the at least one of the set of sustainable activities to the rewards points that are set to expire for the at least one of the second set of users; and
provide at least one of the set of sustainable activities to the first issuer server to receive a confirmation of donation of the rewards points to the set of sustainable activities.

19. The system of claim 12, wherein the rewards server is further configured to:
generate, associated with the notification, a redemption request for an acquirer server to redeem, by at least one of the targeted set of users, one or more of the identified rewards points of the at least one of the targeted set of users based on the confirmation to donate, to one or more of the set of sustainable activities, the one or more of the identified rewards points;
determine that the one or more of the identified rewards points have been successfully redeemed based on a redemption response from the acquirer server; and
authorize donation of the one or more of the identified rewards points that are successfully redeemed to the one or more of the set of sustainable activities based on the determination of successful redemption.

20. The system of claim 12, wherein
the rewards points correspond to one of cashback points, loyalty points, gift coupons, and bonuses,
the set of sustainable activities corresponds to at least one of environmental conservation, animal welfare, sustainable development, or community development, and
the set of sustainable initiatives correspond to at least one of farming and agriculture, gardening and landscaping services, environmental services, renewable energy products and services, environmental and ecological organizations, recycling centers, green products and services, and biofuels.
